(19) United States
(12) Patent Application Publication
(10) Pub. No.: US 2026/0343512 A1
(43) Pub. Date: Oct. 29, 2026

(54) METHOD AND DEVICE FOR DETERMINING BAND INFORMATION, DEVICE, MEDIUM, AND PROGRAM PRODUCT

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/116,005

(22) PCT Filed: Sep. 29, 2022
(86) PCT No.: PCT/CN2022/122892

§ 371 Date: Mar. 27, 2025

(51) Int. Cl. H04W 72/0457; H04W 72/0453

(52) U.S. Cl. CPC H04W 72/0457; H04W 72/0453

(57) ABSTRACT

A method for determining frequency band information is provided. The method for determining frequency band information is performed by a terminal device in a communication system, and includes at least the following step: making a determination whether at least two frequency bands have a capability to support uplink concurrent transmission.

### CROSS-REFERENCE TO RELATED APPLICATIONS

The present application is a U.S. National Stage of International Application No. PCT/CN 2022/122892, filed on Sep. 29, 2022, the contents of all of which are incorporated herein by reference in their entireties for all purposes.

### BACKGROUND OF THE INVENTION

In new radio (NR), the concept of uplink Tx switching is proposed. According to uplink Tx switching, a terminal device needs to support uplink transmission and switching of up to three or four bands.

In a case where the terminal device supports the uplink Tx switching, a method for using an uplink band needs to be further designed.

### SUMMARY OF THE INVENTION

According to an aspect of the embodiments of the present disclosure, a method for determining band information is provided. The method includes: determining whether at least two bands support uplink concurrent transmission.

According to another aspect of the embodiments of the present disclosure, a method for determining band information is provided. The method includes: sending indication signaling, where the indication signaling is used for a terminal device to determine whether at least two bands support uplink concurrent transmission.

According to another aspect of the embodiments of the present disclosure, a terminal device is provided. The terminal device includes: one or more processors; and a transceiver connected to the one or more processors; where The one or more processors are collectively configured to: determine whether at least two bands support uplink concurrent transmission

### BRIEF DESCRIPTION OF DRAWINGS

To illustrate the technical solutions in the embodiments of the present disclosure more clearly, the following will briefly introduce the accompanying drawings needed for describing the embodiments. It is clear that the accompanying drawings in the following descriptions are merely some embodiments of the present disclosure, and those of ordinary skill in the art may further obtain other accompanying drawings from these accompanying drawings without creative efforts.

FIG. 1 is a schematic diagram of a mobile communication system according to an example of the present disclosure.

FIG. 2 is a schematic diagram of a method for determining band information according to an example of the present disclosure.

FIG. 3 is a schematic diagram of a method for determining band information according to an example of the present disclosure.

FIG. 4 is a schematic diagram of a method for determining band information according to an example of the present disclosure.

FIG. 5 is a schematic diagram of a method for determining band information according to an example of the present disclosure.

FIG. 6 is a schematic diagram of a method for determining band information according to an example of the present disclosure.

FIG. 7 is a schematic diagram of a method for determining band information according to an example of the present disclosure.

FIG. 8 is a schematic diagram of a method for determining band information according to an example of the present disclosure.

FIG. 9 is a schematic diagram of a method for determining band information according to an example of the present disclosure.

FIG. 10 is a schematic diagram of a method for determining band information according to an example of the present disclosure.

FIG. 11 is a schematic diagram of a method for determining band information according to an example of the present disclosure.

FIG. 12 is a schematic block diagram of a device for determining band information according to an example of the present disclosure.

FIG. 13 is a schematic block diagram of a device for determining band information according to an example of the present disclosure.

FIG. 14 is a schematic structural diagram of a terminal device according to an example of the present disclosure.

FIG. 15 is a schematic structural diagram of a network device according to an example of the present disclosure.

### DETAILED DESCRIPTION OF THE INVENTION

To make objectives, technical solutions, and advantages of the present disclosure clearer, the following further describes implementations of the present disclosure in detail with reference to the accompanying drawings.

Examples are illustrated in detail here, with examples shown in the accompanying drawings. When the following description involves the accompanying drawings, unless specified otherwise, identical numbers in different accompanying drawings represent same or similar elements, unless otherwise specified. Implementations described in the following examples do not represent all implementations consistent with the present disclosure. On the contrary, the implementations are only examples of devices and methods that are described in the appended claims in detail and that are consistent with some aspects of the present disclosure.

The terms used in the present disclosure are merely for the purpose of illustrating specific embodiments, and are not intended to limit the present disclosure. The terms “a”, “an”, “said”, and “the” of singular forms used in the present disclosure and the appended claims are also intended to include plural forms, unless otherwise specified in the context clearly. It is also to be understood that, the term “and/or” used here indicates and includes any or all combinations of one or more associated listed items.

It is to be noted that user information (including but not limited to user equipment information, personal information of a user, and the like), and data (including but not limited to data used for analysis, stored data, displayed data, and the like) in the present disclosure are information and date used under authorization by the user or full authorization by all parties, and capturing, use, and processing of related data need to conform to related laws, regulations, and standards of related countries and regions.

It is to be understood that although terms such as “first” and “second” may be used in the present disclosure to describe pieces of information, these pieces of information are not limited by these terms. These terms are merely used to distinguish between pieces of information of a same type. For example, without departing from the scope of the present disclosure, a first parameter may also be referred to as a second parameter. Similarly, a second parameter may also be referred to as a first parameter. Depending on the context, for example, the word “if” used here may be explained as “while” or “when” or “in response to determining”.

Embodiments of the present disclosure relate to the field of mobile communications, and in particular, to a method and device for determining band information, a device, a medium, and a program product.

The following briefly describes some key terms in the present disclosure.

Frequency band (also be referred to as band): means a frequency range. The band may have an identifier, and bands of different identifiers correspond to different frequency ranges. For example, the bands include, but are not limited to, a band n1, a band n22, a band n72, and the like, each band corresponds to a frequency range, and each band has its own index or name.

Band switching: A terminal device supports at least two antennas and at least one band. In an uplink transmission scenario, each antenna can target one band, and one band can be targeted by at least two antennas simultaneously. “Target” means that the terminal device can send uplink data to a targeted band via an antenna. Band switching means that one antenna of the terminal device is switched from targeting one band to targeting another band.

Uplink concurrent transmission: The terminal device supports at least two antennas, and each antenna can target one band. It is assumed that a first antenna targets a first band, and a second antenna targets a second band. The first antenna sends uplink data on the first band by using a first port, and the second antenna sends uplink data on the second band by using a second port, which is band concurrent transmission.

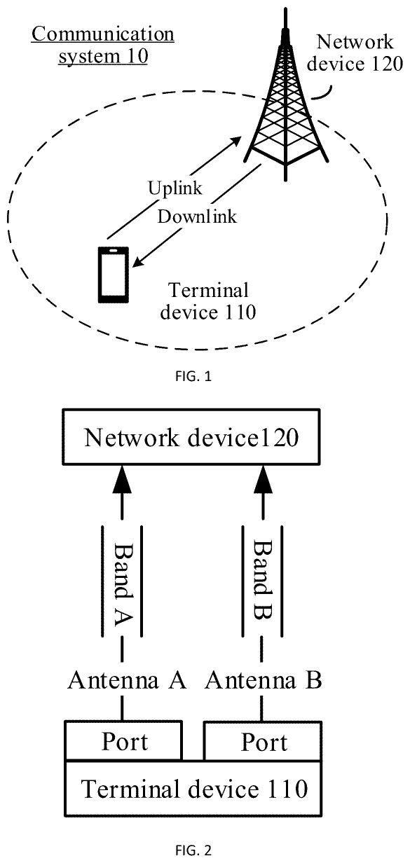

FIG. 1 is a schematic diagram of a communication system 10 according to an example of the present disclosure. The communication system 10 includes a terminal device 110 and a network device 120.

There may be usually a plurality of terminal devices 110. One or more terminal devices 110 may be distributed in a cell managed by each network device 120. The terminal device 110 may include various handheld devices, vehicle-mounted devices, wearable devices, or computing devices with a wireless communication function, or other processing devices connected to a wireless modem, and various forms of user equipments (UEs), mobile stations (MSs), or the like. For ease of description, in the embodiments of the present disclosure, the devices mentioned are collectively referred to as a terminal device.

The network device 120 is a device deployed in an access network to provide a wireless communication function for the terminal device 110. For ease of description, in the embodiments of the present disclosure, the devices that provide a wireless communication function for the terminal device 110 are collectively referred to as a network device. A connection may be established between the network device 120 and the terminal device 110 via an air interface, so that the network device 120 communicates with the terminal device 110 through the connection, including signaling and data interaction. There may be a plurality of network devices 120, and two adjacent network devices 120 may communicate with each other in a wired or wireless manner. The terminal device 110 may send a beam report between different network devices 120, that is, establish a connection with different network devices 120.

The network device 120 may include various forms of macro base stations, micro base stations, relay stations, access points, or the like. In systems using different radio access technologies, names of devices with a network device function may be different. For example, in a 5G NR (New Radio) system, the device having the network device function is referred to as gNodeB or gNB. With the evolution of communication technologies, the name “network device” may change.

The “5G NR system” in the embodiments of the present disclosure may also be referred to as a 5G system or an NR system, and the meaning of which can be understood by those skilled in the art. The technical solutions described in the embodiments of the present disclosure are applicable to the 5G NR system or a subsequently evolved system of the 5G NR system.

FIG. 2 is a schematic diagram of uplink concurrent transmission according to an example of the present disclosure.

The terminal device supports at least two uplink antennas and at least one band, each uplink antenna can target one band, and one band is targeted by up to two uplink antennas. “Target” means that the terminal device can send uplink data to a targeted band via an uplink antenna. To improve efficiency of sending the uplink data, the uplink data can be sent concurrently, that is, at least two sending processes are performed on a same device in a same time period, so whether the band targeted by the uplink antenna supports uplink concurrent transmission needs to be determined.

As shown in FIG. 2, there are two ports on the terminal device 110, which support an antenna A and an antenna B respectively. The antenna A targets a band A, and the antenna B targets a band B. The terminal device 110 sends uplink data to the network device 120 via the antenna A and the antenna B. In a case where the two antennas can send uplink data on the band A and the band B by using the two ports respectively in a same time period, it is determined that the band A and the band B support uplink concurrent transmission. In a case where the band A and the band B can only send the uplink data successively in the same time period, it is determined that the band A and the band B do not support uplink concurrent transmission.

In conclusion, in the embodiment, it is determined that at least two bands support uplink concurrent transmission by the terminal device. This improves a transmission rate of uplink data and reduces congestion or interference of uplink data transmission. In this way, the terminal device can conveniently select a switched band.

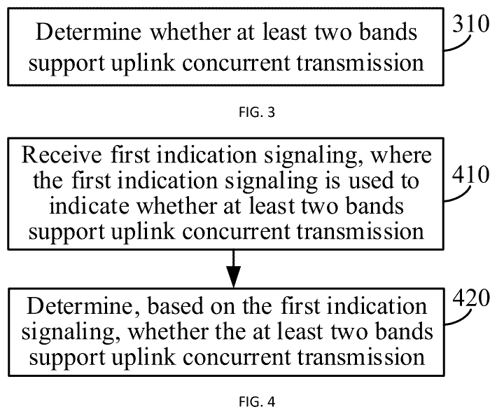

FIG. 3 is a schematic diagram of a method for determining band information according to an example of the present disclosure. In the embodiment, an example in which the method is performed by a terminal device is used for description. The method includes the following step 310.

Step 310: Determine whether at least two bands support uplink concurrent transmission.

The terminal device determines whether the at least two bands support uplink concurrent transmission. For example, the terminal device is provided with an antenna A and an antenna B, which target a band A and a band B respectively. In a case where the two antennas can send uplink data on the band A and the band B respectively by using one port in a same time period, it is determined that the band A and the band B support uplink concurrent transmission.

For example, the terminal device receives indication signaling and determines, based on the indication signaling, whether the at least two bands support uplink concurrent transmission. The indication signaling is sent by a network device. For example, the indication signaling is at least one of radio resource control (RRC) signaling, a media access control control element (MAC CE), or downlink control information (DCI).

In some embodiments, the terminal device notifies, by performing reporting by using a capability of the terminal device or sending uplink control information, a base station of a preparation time of switching an antenna by the terminal device. The terminal device expects that the base station does not perform any uplink scheduling for the terminal device during the preparation time.

In conclusion, in the embodiment, it is determined by the terminal device that at least two bands support uplink concurrent transmission. This improves a transmission rate of uplink data and reduces congestion or interference of uplink data transmission. In this way, the terminal device can conveniently select a switched band.

FIG. 4 is a schematic diagram of a method for determining band information according to an example of the present disclosure. In the embodiment, an example in which the method is performed by a terminal device is used for description. The method includes the following steps 410 to 420.

Step 410: Receive first indication signaling, where the first indication signaling is used to indicate whether at least two bands support uplink concurrent transmission.

The terminal device receives the first indication signaling. The first indication signaling carries at least one or any one of a bitmap, a code point, and single-bit information.

Step 420: Determine, based on the first indication signaling, whether the at least two bands support uplink concurrent transmission.

In some embodiments, the first indication signaling carries a bitmap, and one bit in the bitmap corresponds to one band pair or one band.

In a case where one bit in the bitmap corresponds to one band pair, and the bit is a first value, it indicates that the band pair corresponding to the bit supports uplink concurrent transmission; and in a case where the bit is a second value, it indicates that the band pair corresponding to the bit does not support uplink concurrent transmission.

For example, in a case where the first value is 1, the second value is 0, a value of the bitmap is 101, and band pairs corresponding to three bits in the bitmap are sequentially a+b, a+c, b+c, the band pair a+b and the band pair b+c support uplink concurrent transmission, and the band pair a+c does not support uplink concurrent transmission.

In some embodiments, a quantity of bits in the bitmap is a first quantity N. In other words, the bitmap includes N bits, and N is a quantity of uplink bands/band pairs supported by the terminal device, a quantity of uplink bands/band pairs configured by a network device, or a preset value.

It is assumed that N is a preset value, and in a case where a quantity of band pairs indicated by the network device or a quantity n1 of band pairs reported by the terminal device is less than the first quantity N, n1 high-order bits in the bitmap are valid bits, and n1 is less than N; and in a case where a quantity of band pairs indicated by the network device or a quantity n2 of band pairs reported by the terminal device is less than the first quantity N, n2 low-order bits in the bitmap are valid bits, and n2 is less than N.

In a case where one bit in the bitmap corresponds to one band, and the bit is a first value, it indicates that a first band corresponding to the bit supports uplink concurrent transmission with a second band, and the second band is a band corresponding to another bit having the first value in the bitmap; and in a case where the bit is a second value, it indicates that the band corresponding to the bit does not support uplink concurrent transmission.

For example, in a case where the first value is 1, the second value is 0, a value of the bitmap is 1001, and bands respectively corresponding to four bits are sequentially a, b, c, and d, the band a and the band d support uplink concurrent transmission, and the band b and the band c do not support uplink concurrent transmission.

In some embodiments, the first indication signaling carries a code point. The code point is a combined value of at least one bit, or is understood as a decimal value corresponding to a value of at least one bit.

In some embodiments, the first indication signaling carries a first code point. The first code point corresponds to a band set and is used to indicate that at least two bands in the band set support uplink concurrent transmission.

For example, in a case where the first code point is 00, and the corresponding band set includes bands a, b, and c, any two of the bands a, b, and c support uplink concurrent transmission.

In a case where the first code point is 01, and the corresponding band set includes bands a, b, and d, any two of the bands a, b, and d support uplink concurrent transmission.

In a case where the first code point is 10, and the corresponding band set includes bands a, c, and d, any two of the bands a, c, and d support uplink concurrent transmission.

In a case where the first code point is 11, and the corresponding band set includes bands b, c, and d, any two of the bands b, c, and d support uplink concurrent transmission.

In some embodiments, the first indication signaling carries a second code point. The second code point corresponds to a band and is used to indicate that the band does not support uplink concurrent transmission with another band.

For example, in a case where the second code point is 00, and the corresponding band is a band d, the band d does not support uplink concurrent transmission.

In a case where the second code point is 01, and the corresponding band is a band c, the band c does not support uplink concurrent transmission.

In a case where the second code point is 10, and the corresponding band is a band b, the band b does not support uplink concurrent transmission.

In a case where the second code point is 11, and the corresponding band is a band a, the band a does not support uplink concurrent transmission.

In some embodiments, in a case where the first indication signaling carries single-bit information, the single-bit information is used to indicate whether a target band supports uplink concurrent transmission.

The target band includes any one of the following:

1. All bands

For example, all bands supported by the terminal device are a band group abcd, and the band a, the band b, the band c, and the band d are target bands.

2. A band that is indicate as allowed for switching

For example, all bands supported by the terminal are the band group abcd. In the band group abcd, the band a and the band c are allowed to be switched, and the band a and the band c are the target bands.

3. A band with a specified priority

For example, in the band group abcd, the band b and the band d have specified priorities, and the band b and the band d are target bands. The specified priority may be a first priority or a second priority. The first priority is higher than the second priority, the first priority may be referred to as a high priority, and the second priority may be referred to as a low priority. In an embodiment, a band with a low priority does not support uplink concurrent transmission, and a band with a high priority supports uplink concurrent transmission.

In a case where the single-bit information is a first value, it indicates that the target band supports uplink concurrent transmission. For example, in a case where a value of the single-bit information is 1, it indicates that any two bands in the target band support uplink concurrent transmission.

In a case where the single-bit information is a second value, it indicates that the target band does not support uplink concurrent transmission. For example, in a case where the value of the single-bit information is 0, it indicates that any two bands in the target band do not support uplink concurrent transmission.

In some embodiments, the terminal device further sends capability information to the network device in advance. The capability information is used to indicate at least one band pair supported by the terminal device. After receiving the capability information, the network device can determine, based on the capability information, the at least one band pair supported by the terminal device. The capability information includes at least one of: a total quantity of bands for uplink transmission supported by the terminal device, an index of a band for uplink transmission supported by the terminal device, a name of a band for uplink transmission supported by the terminal device, or an index of a band group for uplink transmission supported by the terminal device.

In conclusion, according to the method for receiving the first indication signaling in the embodiment, in a case where the first indication signaling carries the bitmap, it can accurately indicate whether any band pair or band supports band concurrent transmission; in a case where the first indication signaling carries the code point, a band can be selected or excluded based on a requirement, and signaling overheads are low; and in a case where the first indication signaling carries the single-bit information, it can integrally indicate whether any band supports band concurrent transmission, and signaling overheads are low.

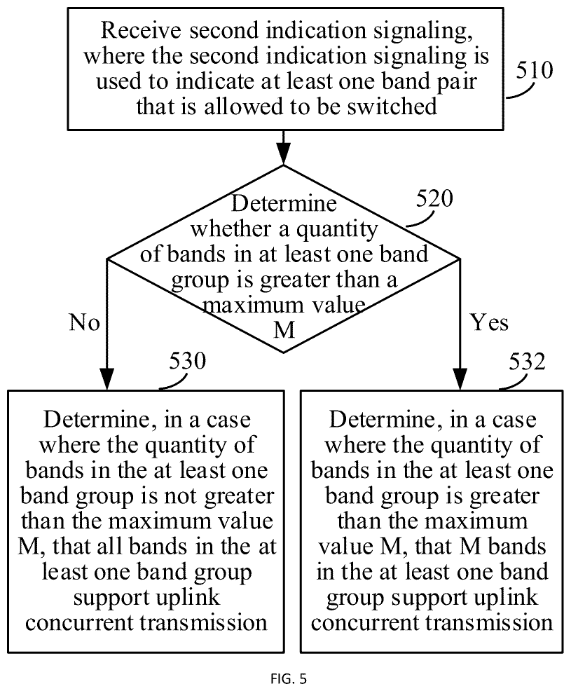

FIG. 5 is a schematic diagram of a method for determining band information according to an example of the present disclosure. In the embodiment, an example in which the method is performed by a terminal device is used for description. The method includes the following steps 510 to 532.

Step 510: Receive second indication signaling, where the second indication signaling is used to indicate at least one band pair that is allowed to be switched.

The terminal device receives the second indication signaling. The second indication signaling is used to indicate one or more band pairs. Two bands in each band pair are allowed to be switched. In other words, an antenna is allowed to be switched from targeting a first band in the band pair to targeting a second band in the band pair. Determining whether the at least two bands support uplink concurrent transmission includes: determining, based on the second indication signaling, whether the at least two bands support uplink concurrent transmission.

For example, band pairs are sequentially a+b, a+c, and b+c. The band a and the band b in the band pair are allowed to be switched, the band a and the band c in the band pair are allowed to be switched, and the band b and the band c in the band pair are allowed to be switched.

Step 520: Determine whether a quantity of bands in at least one band group is greater than a maximum value M.

In a case where the quantity of bands in the at least one band group is not greater than the maximum value M, step 530 is performed. In a case where the quantity of bands in the at least one band group is greater than the maximum value M, step 532 is performed.

Step 530: Determine, in a case where the quantity of bands in the at least one band group is not greater than the maximum value M, that all bands in the at least one band group support uplink concurrent transmission.

For example, in a case where the maximum value M is 3, and the quantity of bands in the at least one band group is 2, any two of bands in the band group support uplink concurrent transmission.

Step 532: Determine, in a case where the quantity of bands in the at least one band group is greater than the maximum value M, that M bands in the at least one band group support uplink concurrent transmission.

For example, in a case where the maximum value M is 3, and the quantity of bands in the at least one band group is 4, three bands in the band group support uplink concurrent transmission.

In some embodiments, the M bands are first M bands in predetermined order in the at least one band group. For example, in a band group abcd, the band a, the band b, and the band c support uplink concurrent transmission.

In some embodiments, the M bands are last M bands in predetermined order in the at least one band group. For example, in the band group abcd, the band b, the band c, and the band d support uplink concurrent transmission.

The predetermined order is any one of a descending order of frequencies, an ascending order of frequencies, an ascending order of indexes of bands, or a descending order of indexes of bands.

In some embodiments, the terminal device further sends capability information to a network device in advance. The capability information is used to indicate at least one band pair supported by the terminal device. After receiving the capability information, the network device can determine, based on the capability information, the at least one band pair supported by the terminal device. The capability information includes at least one of: a total quantity of bands for uplink transmission supported by the terminal device, an index of a band for uplink transmission supported by the terminal device, a name of a band for uplink transmission supported by the terminal device, or an index of a band group for uplink transmission supported by the terminal device.

In some embodiments, the terminal device reports the maximum value M to the network device in advance. The maximum value M is a maximum quantity of bands for uplink concurrent transmission supported by the terminal device. In some embodiments, the maximum value M is configured by the network device or predefined in a protocol.

In some embodiments, the terminal device reports the maximum value M to the network device in advance. The maximum value M is a maximum quantity of band pairs for uplink concurrent transmission supported by the terminal device. The terminal device determines that all band pairs in the at least one band group support uplink concurrent transmission in a case where the quantity of band pairs in the at least one band group is not greater than the maximum value M; and determines that M band pairs in the at least one band group support uplink concurrent transmission in a case where the quantity of band pairs in the at least one band group is greater than the maximum value M.

In conclusion, according to the method for receiving the second indication signaling in the embodiment, whether the quantity of bands in the at least one band group is greater than the maximum value M is determined, so that a specific band supporting uplink concurrent transmission is determined.

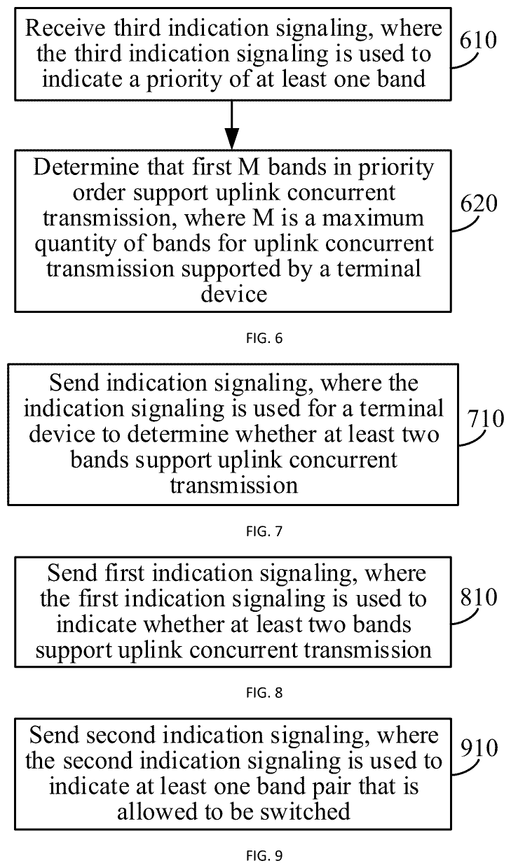

FIG. 6 is a schematic diagram of a method for determining band information according to an example of the present disclosure. In the embodiment, an example in which the method is performed by a terminal device is used for description. The method includes the following steps 610 to 620.

Step 610: Receive third indication signaling, where the third indication signaling is used to indicate a priority of at least one band.

The terminal device receives the third indication signaling. For example, in a band group abcd, the third indication signaling is used to indicate a priority of at least one of the band a, the band b, the band c, or the band d. Determining whether the at least two bands support uplink concurrent transmission includes: determining, based on the third indication signaling, whether the at least two bands support uplink concurrent transmission.

In some embodiments, the priority is divided into a first priority and a second priority, and the first priority is higher than the second priority. The first priority may be referred to as a high priority, and the second priority may be referred to as a low priority. Each band has the first priority or the second priority.

Step 620: Determine that first M bands in priority order support uplink concurrent transmission, where M is a maximum quantity of bands for uplink concurrent transmission supported by the terminal device.

The terminal device sorts a plurality of bands in descending order of priorities. A plurality of bands with a same priority may be sorted in frequency domain order.

The terminal device determines that the first M bands in priority order support uplink concurrent transmission. For example, in the band group abcd sorted in priority order, the maximum value M is 3, and the first three bands support uplink concurrent transmission, that is, the band a, the band b, and the band c support uplink concurrent transmission.

In some embodiments, the terminal device further sends capability information to a network device in advance. The capability information is used to indicate at least one band pair supported by the terminal device. After receiving the capability information, the network device can determine, based on the capability information, the at least one band pair supported by the terminal device. The capability information includes at least one of: a total quantity of bands for uplink transmission supported by the terminal device, an index of a band for uplink transmission supported by the terminal device, a name of a band for uplink transmission supported by the terminal device, or an index of a band group for uplink transmission supported by the terminal device.

In some embodiments, the terminal device reports the maximum value M to the network device in advance. The maximum value M is a maximum quantity of bands for uplink concurrent transmission supported by the terminal device. In some embodiments, the maximum value M is configured by the network device or predefined in a protocol.

In conclusion, according to the method for receiving the third indication signaling in the embodiment, it is determined that the first M bands in priority order support uplink concurrent transmission, so that a specific band supporting uplink concurrent transmission is determined.

FIG. 7 is a schematic diagram of a method for determining band information according to an example of the present disclosure. In the embodiment, an example in which the method is performed by a network device is used for description. The method includes the following step 710.

Step 710: Send indication signaling, where the indication signaling is used for a terminal device to determine whether at least two bands support uplink concurrent transmission.

The indication signaling in the embodiment of the present disclosure is RRC signaling, a MAC CE, DCI, or a combination of at least two pieces of signaling, which is not limited in embodiments of the present disclosure.

In some embodiments, a base station indicates, via downlink signaling, to a terminal device a preparation time of switching an antenna by the terminal device. The base station does not perform any uplink scheduling for the terminal device during the preparation time. The downlink signaling includes, but is not limited to, the RRC signaling, the MAC CE, and the DCI.

In conclusion, in the embodiment, the network device sends the indication signaling, and the indication signaling is used for the terminal device to determine that at least two bands support uplink concurrent transmission. This improves a transmission rate of uplink data and reduces congestion or interference of uplink data transmission. In this way, the terminal device can conveniently select a switched band.

FIG. 8 is a schematic diagram of a method for determining band information according to an example of the present disclosure. In the embodiment, an example in which the method is performed by a network device is used for description. The method includes the following step 810.

Step 810: Send first indication signaling, where the first indication signaling is used to indicate whether at least two bands support uplink concurrent transmission.

The network device sends the first indication signaling. The first indication signaling carries at least one or any one of a bitmap, a code point, or single-bit information. Related principles have been illustrated in step 410. Details are not described here again.

In some embodiments, the network device receives capability information sent by a terminal device. The capability information is used to indicate at least one band pair supported by the terminal device. After receiving the capability information, the network device can determine, based on the capability information, the at least one band pair supported by the terminal device. The capability information includes at least one of: a total quantity of bands for uplink transmission supported by the terminal device, an index of a band for uplink transmission supported by the terminal device, a name of a band for uplink transmission supported by the terminal device, or an index of a band group for uplink transmission supported by the terminal device.

In conclusion, according to the method for sending the first indication signaling in the embodiment, in a case where the first indication signaling carries the bitmap, it can accurately indicate whether any band pair or band supports band concurrent transmission;
in a case where the first indication signaling carries the code point, a band can be selected or excluded based on a requirement, and signaling overheads are low; and
in a case where the first indication signaling carries the single-bit information, it can integrally indicate whether any band supports band concurrent transmission, and signaling overheads are low.

FIG. 9 is a schematic diagram of a method for determining band information according to an example of the present disclosure. In the embodiment, an example in which the method is performed by a network device is used for description. The method includes the following step 910.

Step 910: Send second indication signaling, where the second indication signaling is used to indicate at least one band pair that is allowed to be switched.

The network device sends the second indication signaling. The second indication signaling is used to indicate one or more band pairs. Two bands in each band pair are allowed to be switched. In other words, an antenna is allowed to be switched from targeting a first band in the band pair to targeting a second band in the band pair.

For example, band pairs are sequentially a+b, a+c, and b+c. The band a and the band b in the band pair are allowed to be switched, the band a and the band c in the band pair are allowed to be switched, and the band b and the band c in the band pair are allowed to be switched.

In a case where a quantity of bands in the at least one band group is not greater than a maximum value M, all bands in the at least one band group support uplink concurrent transmission. For example, in a case where the maximum value M is 3, and the quantity of bands in the at least one band group is 2, any two of bands in the band group support uplink concurrent transmission.

In a case where the quantity of bands in the at least one band group is greater than the maximum value M, M bands in the at least one band group support uplink concurrent transmission. For example, in a case where the maximum value M is 3, and the quantity of bands in the at least one band group is 4, three bands in the band group support uplink concurrent transmission.

In some embodiments, the M bands are first M bands in predetermined order in the at least one band group. For example, in a band group abcd, the band a, the band b, and the band c support uplink concurrent transmission.

In some embodiments, the M bands are last M bands in predetermined order in the at least one band group. For example, in the band group abcd, the band b, the band c, and the band d support uplink concurrent transmission.

The predetermined order is any one of a descending order of frequencies, an ascending order of frequencies, an ascending order of indexes of bands, or a descending order of indexes of bands.

In some embodiments, the network device receives capability information sent by a terminal device. The capability information is used to indicate at least one band pair supported by the terminal device. After receiving the capability information, the network device can determine, based on the capability information, the at least one band pair supported by the terminal device. The capability information includes at least one of: a total quantity of bands for uplink transmission supported by the terminal device, an index of a band for uplink transmission supported by the terminal device, a name of a band for uplink transmission supported by the terminal device, or an index of a band group for uplink transmission supported by the terminal device.

In some embodiments, the network device receives the maximum value M sent by the terminal device. The maximum value M is a maximum quantity of bands for uplink concurrent transmission supported by the terminal device. In some embodiments, the maximum value M is configured by the network device or predefined in a protocol.

In conclusion, according to the method for sending the second indication signaling in the embodiment, whether the quantity of bands in the at least one band group is greater than the maximum value M is determined, so that a specific band supporting uplink concurrent transmission is determined.

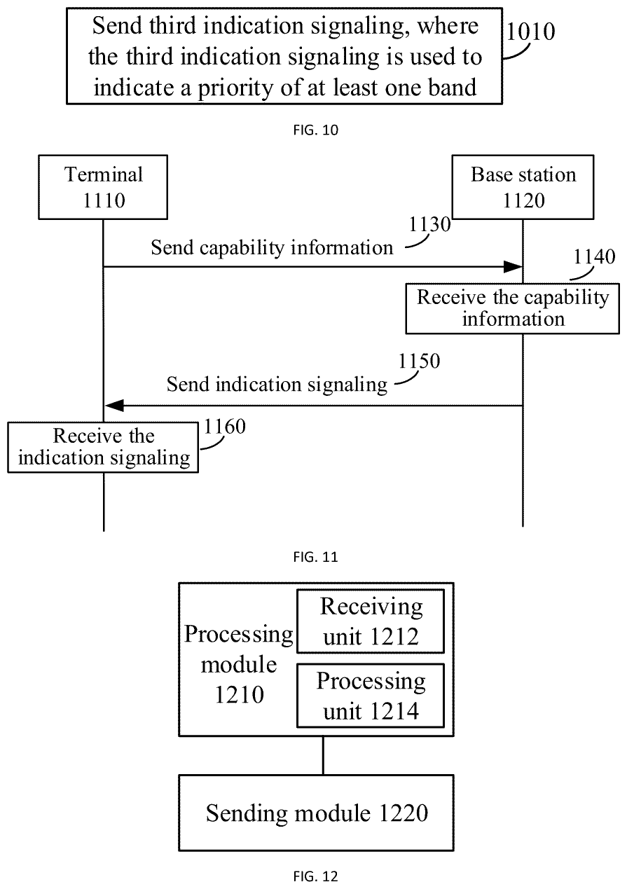

FIG. 10 is a schematic diagram of a method for determining band information according to an example of the present disclosure. In the embodiment, an example in which the method is performed by a network device is used for description. The method includes the following step 1010.

Step 1010: Send third indication signaling, where the third indication signaling is used to indicate a priority of at least one band.

The network device sends the third indication signaling. For example, in a band group abcd, the third indication signaling is used to indicate a priority of at least one of the band a, the band b, the band c, or the band d.

In some embodiments, the priority is divided into a first priority and a second priority, and the first priority is higher than the second priority. The first priority may be referred to as a high priority, and the second priority may be referred to as a low priority. Each band has the first priority or the second priority.

The terminal device sorts a plurality of bands in descending order of priorities. A plurality of bands with a same priority may be sorted in frequency domain order.

First M bands sorted in priority order support uplink concurrent transmission. For example, in the band group abcd sorted in priority order, the maximum value M is 3, and the first three bands support uplink concurrent transmission, that is, the band a, the band b, and the band c support uplink concurrent transmission.

In some embodiments, the network device receives capability information sent by the terminal device. The capability information is used to indicate at least one band pair supported by the terminal device. After receiving the capability information, the network device can determine, based on the capability information, the at least one band pair supported by the terminal device. The capability information includes at least one of: a total quantity of bands for uplink transmission supported by the terminal device, an index of a band for uplink transmission supported by the terminal device, a name of a band for uplink transmission supported by the terminal device, or an index of a band group for uplink transmission supported by the terminal device.

In some embodiments, the network device receives the maximum value M sent by the terminal device. The maximum value M is a maximum quantity of bands for uplink concurrent transmission supported by the terminal device. In some embodiments, the maximum value M is configured by the network device or predefined in a protocol.

In conclusion, according to the method for sending the third indication signaling in the embodiment, it is determined that the first M bands in priority order support uplink concurrent transmission, so that a specific band supporting uplink concurrent transmission is determined.

FIG. 11 is a schematic diagram of a method for determining band information according to an example of the present disclosure. An example in which a terminal device is a terminal 1110, and a network device is a base station 1120 is used for description the method for determining band information. The method for determining band information includes the steps 1130 to 1160.

Step 1130: The terminal sends capability information.

The terminal sends the capability information to the base station in advance. The capability information is used to indicate at least one band pair supported by the terminal. After receiving the capability information, the base station can determine, based on the capability information, the at least one band pair supported by the terminal. The capability information includes at least one of: a total quantity of bands for uplink transmission supported by the terminal, an index of a band for uplink transmission supported by the terminal, a name of a band for uplink transmission supported by the terminal, or an index of a band group for uplink transmission supported by the terminal.

Step 1140: The base station receives the capability information.

The base station receives the capability information sent by the terminal and performs step 1150 based on the capability information.

Step 1150: The base station sends indication signaling.

The base station sends the indication signaling to the terminal based on the received capability information. The indication signaling includes at least one of first indication signaling, second indication signaling, or third indication signaling.

In a case where the indication signaling is the first indication signaling, the first indication signaling carries at least one or any one of a bitmap, a code point, or single-bit information.

In some embodiments, the first indication signaling carries a bitmap, and one bit in the bitmap corresponds to one band pair or one band.

In a case where the one bit in the bitmap corresponds to the one band pair, and the bit is a first value, it indicates that the band pair corresponding to the bit supports uplink concurrent transmission; and in a case where the bit is a second value, it indicates that the band pair corresponding to the bit does not support uplink concurrent transmission.

For example, in a case where the first value is 1, the second value is 0, a value of the bitmap is 101, and band pairs corresponding to three bits in the bitmap are sequentially a+b, a+c, b+c, the band pair a+b and the band pair b+c support uplink concurrent transmission, and the band pair a+c does not support uplink concurrent transmission.

In some embodiments, a quantity of bits in the bitmap is a first quantity N. In other words, the bitmap includes N bits, and N is a quantity of uplink bands/band pairs supported by the terminal, a quantity of uplink bands/band pairs configured by the base station, or a preset value.

It is assumed that N is a preset value, and in a case where a quantity of band pairs indicated by the base station or a quantity n1 of band pairs reported by the terminal is less than the first quantity N, n1 high-order bits in the bitmap are valid bits, and n1 is less than N; and in a case where a quantity of band pairs indicated by the base station or a quantity n2 of band pairs reported by the terminal is less than the first quantity N, n2 low-order bits in the bitmap are valid bits, and n2 is less than N.

In a case where one bit in the bitmap corresponds to one band, and the bit is a first value, it indicates that a first band corresponding to the bit supports uplink concurrent transmission with a second band, and the second band is a band corresponding to another bit having the first value in the bitmap; and in a case where the bit is a second value, it indicates that the band corresponding to the bit does not support uplink concurrent transmission.

For example, in a case where the first value is 1, the second value is 0, a value of the bitmap is 1001, and bands respectively corresponding to four bits are sequentially a, b, c, and d, the band a and the band d support uplink concurrent transmission, and the band b and the band c do not support uplink concurrent transmission.

In some embodiments, the first indication signaling carries a code point. The code point is a combined value of at least one bit, or is understood as a decimal value corresponding to a value of the at least one bit.

In some embodiments, the first indication signaling carries a first code point. The first code point corresponds to a band set and is used to indicate that at least two bands in the band set support uplink concurrent transmission.

For example, in a case where the first code point is 00, and the corresponding band set includes bands a, b, and c, any two of the bands a, b, and c support uplink concurrent transmission.

In a case where the first code point is 01, and the corresponding band set includes bands a, b, and d, any two of the bands a, b, and d support uplink concurrent transmission.

In a case where the first code point is 10, and the corresponding band set includes bands a, c, and d, any two of the bands a, c, and d support uplink concurrent transmission.

In a case where the first code point is 11, and the corresponding band set includes bands b, c, and d, any two of the bands b, c, and d support uplink concurrent transmission.

In some embodiments, the first indication signaling carries a second code point. The second code point corresponds to a band and is used to indicate that the band does not support uplink concurrent transmission with another band.

For example, in a case where the second code point is 00, and the corresponding band is a band d, the band d does not support uplink concurrent transmission.

In a case where the second code point is 01, and the corresponding band is a band c, the band c does not support uplink concurrent transmission.

In a case where the second code point is 10, and the corresponding band is a band b, the band b does not support uplink concurrent transmission.

In a case where the second code point is 11, and the corresponding band is a band a, the band a does not support uplink concurrent transmission.

In some embodiments, in a case where the first indication signaling carries single-bit information, the single-bit information is used to indicate whether a target band supports uplink concurrent transmission.

The target band includes any one of the following:

1. All bands

For example, all bands supported by the terminal device are a band group abcd, and the band a, the band b, the band c, and the band d are target bands.

2. A band that is indicate as allowed for switching

For example, all bands supported by the terminal are the band group abcd. In the band group abcd, the band a and the band c are allowed to be switched, and the band a and the band c are the target bands.

3. A band with a specified priority

For example, in the band group abcd, the band b and the band d have specified priorities, and the band b and the band d are target bands. The specified priority may be a first priority or a second priority. The first priority is higher than the second priority, the first priority may be referred to as a high priority, and the second priority may be referred to as a low priority. In an embodiment, a band with a low priority does not support uplink concurrent transmission, and a band with a high priority supports uplink concurrent transmission.

In a case where the single-bit information is a first value, it indicates that the target band supports uplink concurrent transmission. For example, in a case where a value of the single-bit information is 1, it indicates that any two bands in the target band support uplink concurrent transmission.

In a case where the single-bit information is a second value, it indicates that the target band does not support uplink concurrent transmission. For example, in a case where the value of the single-bit information is 0, it indicates that any two bands in the target band do not support uplink concurrent transmission.

In a case where the indication signaling is the second indication signaling, the base station sends the second indication signaling. The second indication signaling is used to indicate one or more band pairs. Two bands in each band pair are allowed to be switched. In other words, an antenna is allowed to be switched from targeting a first band in the band pair to targeting a second band in the band pair.

For example, band pairs are sequentially a+b, a+c, and b+c. The band a and the band b in the band pair are allowed to be switched, the band a and the band c in the band pair are allowed to be switched, and the band b and the band c in the band pair are allowed to be switched.

In a case where a quantity of bands in the at least one band group is not greater than a maximum value M, all bands in the at least one band group support uplink concurrent transmission. For example, in a case where the maximum value M is 3, and the quantity of bands in the at least one band group is 2, any two of all bands in the band group support uplink concurrent transmission.

In a case where the quantity of bands in the at least one band group is greater than the maximum value M, M bands in the at least one band group support uplink concurrent transmission. For example, in a case where the maximum value M is 3, and the quantity of bands in the at least one band group is 4, three bands in the band group support uplink concurrent transmission.

In some embodiments, the M bands are first M bands in predetermined order in the at least one band group. For example, in a band group abcd, the band a, the band b, and the band c support uplink concurrent transmission.

In some embodiments, the M bands are last M bands in predetermined order in the at least one band group. For example, in the band group abcd, the band b, the band c, and the band d support uplink concurrent transmission.

The predetermined order is any one of a descending order of frequencies, an ascending order of frequencies, an ascending order of indexes of bands, or a descending order of indexes of bands.

In some embodiments, the base station receives the maximum value M sent by the terminal. The maximum value M is a maximum quantity of bands for uplink concurrent transmission supported by the terminal. In some embodiments, the maximum value M is configured by the base station or predefined in a protocol.

In a case where the indication signaling is the third indication signaling, the base station sends the third indication signaling. For example, in a band group abcd, the third indication signaling is used to indicate a priority of at least one of the band a, the band b, the band c, or the band d.

In some embodiments, the priority is divided into a first priority and a second priority, and the first priority is higher than the second priority. The first priority may be referred to as a high priority, and the second priority may be referred to as a low priority. Each band has the first priority or the second priority.

The terminal sorts a plurality of bands in descending order of priorities. A plurality of bands with a same priority may be sorted in frequency domain order.

First M bands in priority order support uplink concurrent transmission. For example, in the band group abcd sorted in priority order, the maximum value M is 3, and the first three bands support uplink concurrent transmission, that is, the band a, the band b, and the band c support uplink concurrent transmission.

In some embodiments, the base station receives the maximum value M sent by the terminal. The maximum value M is a maximum quantity of bands for uplink concurrent transmission supported by the terminal. In some embodiments, the maximum value M is configured by the base station or predefined in a protocol.

Step 1160: The terminal receives the indication signaling.

The terminal receives the indication signaling. The indication signaling includes at least one of the first indication signaling, the second indication signaling, or the third indication signaling.

In a case where the indication signaling is the first indication signaling, the first indication signaling carries at least one or any one of a bitmap, a code point, or single-bit information. Determining whether the at least two bands support uplink concurrent transmission includes: determining, based on the first indication signaling, whether the at least two bands support uplink concurrent transmission. Related principles have been illustrated in step 1150. Details are not described here again.

In a case where the indication signaling is the second indication signaling, the terminal receives the second indication signaling. The second indication signaling is used to indicate one or more band pairs. Two bands in each band pair are allowed to be switched. In other words, an antenna is allowed to be switched from targeting a first band in the band pair to targeting a second band in the band pair. Determining whether the at least two bands support uplink concurrent transmission includes: determining, based on the second indication signaling, whether the at least two bands support uplink concurrent transmission.

For example, band pairs are sequentially a+b, a+c, and b+c. The band a and the band b in the band pair are allowed to be switched, the band a and the band c in the band pair are allowed to be switched, and the band b and the band c in the band pair are allowed to be switched.

In a case where a quantity of bands in the at least one band group is not greater than the maximum value M, the terminal determines that all bands in the at least one band group support uplink concurrent transmission. For example, in a case where the maximum value M is 3, and the quantity of bands in the at least one band group is 2, any two of all bands in the band group support uplink concurrent transmission.

In a case where the quantity of bands in the at least one band group is greater than the maximum value M, the terminal determines that M bands in the at least one band group support uplink concurrent transmission. For example, in a case where the maximum value M is 3, and the quantity of bands in the at least one band group is 4, three bands in the band group support uplink concurrent transmission.

In some embodiments, the M bands are first M bands in predetermined order in the at least one band group. For example, in a band group abcd, the band a, the band b, and the band c support uplink concurrent transmission.

In some embodiments, the M bands are last M bands in predetermined order in the at least one band group. For example, in the band group abcd, the band b, the band c, and the band d support uplink concurrent transmission.

The predetermined order is any one of a descending order of frequencies, an ascending order of frequencies, an ascending order of indexes of bands, or a descending order of indexes of bands.

In some embodiments, the terminal further reports the maximum value M to the base station in advance. The maximum value M is a maximum quantity of bands for uplink concurrent transmission supported by the terminal. In some embodiments, the maximum value M is configured by the base station or predefined in a protocol.

In a case where the indication signaling is the third indication signaling, the terminal receives the third indication signaling. The third indication signaling is used to indicate a priority of at least one band. For example, in a band group abcd, the third indication signaling is used to indicate a priority of at least one of the band a, the band b, the band c, or the band d. Determining whether the at least two bands support uplink concurrent transmission includes: determining, based on the third indication signaling, whether the at least two bands support uplink concurrent transmission.

In some embodiments, the priority is divided into a first priority and a second priority, and the first priority is higher than the second priority. The first priority may be referred to as a high priority, and the second priority may be referred to as a low priority. Each band has the first priority or the second priority.

The terminal sorts a plurality of bands in descending order of priorities. A plurality of bands with a same priority may be sorted in frequency domain order.

The terminal determines that first M bands in priority order support uplink concurrent transmission. For example, in the band group abcd sorted in priority order, the maximum value M is 3, and first three bands support uplink concurrent transmission, that is, the band a, the band b, and the band c support uplink concurrent transmission.

In some embodiments, the terminal further reports the maximum value M to the base station in advance. The maximum value M is a maximum quantity of bands for uplink concurrent transmission supported by the terminal. In some embodiments, the maximum value M is configured by the base station or predefined in a protocol.

In conclusion, in the embodiment, the terminal receives the indication signaling, the base station sends the indication signaling, and the indication signaling is used for the terminal to determine that at least two bands support uplink concurrent transmission. This improves a transmission rate of uplink data and reduces congestion or interference of uplink data transmission. In this way, the terminal can conveniently select a switched band.

According to the method for receiving and sending the first indication signaling, in a case where the first indication signaling carries the bitmap, it can accurately indicate whether any band pair or band supports band concurrent transmission;
in a case where the first indication signaling carries the code point, a band can be selected or excluded based on a requirement, and signaling overheads are low; and
in a case where the first indication signaling carries the single-bit information, it can integrally indicate whether any band supports band concurrent transmission, and signaling overheads are low.

According to the method for receiving and sending the second indication signaling, whether the quantity of bands in the at least one band group is greater than the maximum value M is determined, so that a specific band supporting uplink concurrent transmission is determined.

According to the method for receiving and sending the third indication signaling, it is determined that the first M bands in priority order support uplink concurrent transmission, so that a specific band supporting uplink concurrent transmission is determined.

FIG. 12 is a schematic block diagram of a device for determining band information according to an example of the present disclosure. The device includes a processing module 1210.

The processing module 1210 is configured to determine whether at least two bands support uplink concurrent transmission.

In some embodiments, the device further includes a sending module 1220, configured to report at least one of: a maximum value M that is a maximum quantity of bands for uplink concurrent transmission supported by a terminal device; a total quantity of bands for uplink transmission supported by the terminal device; an index of a band for uplink transmission supported by the terminal device; a name of a band for uplink transmission supported by the terminal device; or an index of a band group for uplink transmission supported by the terminal device.

In an embodiment, the processing module 1210 includes a receiving unit 1212 and a processing unit 1214.

The receiving unit 1212 is configured to receive first indication signaling used to indicate whether the at least two bands support uplink concurrent transmission, or receive second indication signaling used to indicate at least one band pair that is allowed to be switched, or receive third indication signaling used to indicate a priority of at least one band.

The processing unit 1214 is configured to determine whether a band supports uplink concurrent transmission.

In an embodiment, the first indication signaling carries a bitmap, and one bit in the bitmap corresponds to one band pair or one band.

In some embodiments, the one bit in the bitmap corresponds to the one band pair.

In a case where a bit is a first value, it indicates that a band pair corresponding to the bit supports uplink concurrent transmission; and
in a case where a bit is a second value, it indicates that a band pair corresponding to the bit does not support uplink concurrent transmission.

In some embodiments, a quantity of bits in the bitmap is a first quantity N.

In a case where a quantity n1 of band pairs indicated by a network device or reported by the terminal device is less than the first quantity N, n1 high-order bits in the bitmap are valid bits, and n1 is less than N; and in a case where a quantity n2 of band pairs indicated by a network device or reported by the terminal device is less than the first quantity N, n2 low-order bits in the bitmap are valid bits, and n2 is less than N.

In some embodiments, one bit in the bitmap corresponds to one band pair.

In a case where a bit is a first value, it indicates that a first band corresponding to the bit supports uplink concurrent transmission with a second band, and the second band is a band corresponding to another bit having the first value in the bitmap; and in a case where the bit is a second value, it indicates that the first band does not support uplink concurrent transmission.

In some embodiments, the first indication signaling carries a first code point. The first code point corresponds to a band set and is used to indicate that at least two bands in the band set support uplink concurrent transmission.

In some embodiments, the first indication signaling carries a second code point. The second code point corresponds to a band and is used to indicate that the band does not support uplink concurrent transmission.

In some embodiments, in a case where the first indication signaling carries single-bit information, the single-bit information is used to indicate whether a target band supports uplink concurrent transmission.

The target band includes any one of: all bands; a band that is indicated as allowed for switching; or a band with a specified priority.

In a case where the single-bit information is a first value, it indicates that the target band supports uplink concurrent transmission; and in a case where the single-bit information is a second value, it indicates that the target band does not support uplink concurrent transmission.

In an embodiment, in a case where a quantity of bands in the at least one band group is not greater than a maximum value M, the processing unit 1214 determines that all bands in the at least one band group support uplink concurrent transmission, and in a case where the quantity of bands in the at least one band group is greater than the maximum value M, determines that M bands in the at least one band group support uplink concurrent transmission.

The M bands are first M bands in predetermined order in the at least one band group; or the M bands are last M bands in predetermined order in the at least one band group. The predetermined order is any one of a descending order of frequencies, an ascending order of frequencies, an ascending order of indexes of bands, or a descending order of indexes of bands.

In an embodiment, the processing unit 1214 determines that first M bands in priority order support uplink concurrent transmission.

M is a maximum quantity of bands for uplink concurrent transmission supported by the terminal device.

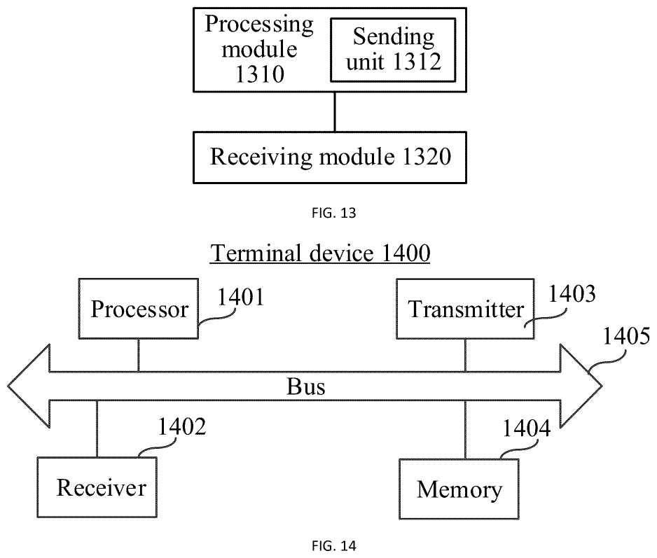

FIG. 13 is a schematic block diagram of a device for determining band information according to an example of the present disclosure. The device includes a processing module 1310.

The processing module 1310, configured to send indication signaling, where the indication signaling is used for a terminal device to determine whether at least two bands support uplink concurrent transmission.

In some embodiments, the device further includes a receiving module 1320, configured to receive at least one of: a maximum value M that is a maximum quantity of bands for uplink concurrent transmission supported by a terminal device; a total quantity of bands for uplink transmission supported by the terminal device; an index of a band for uplink transmission supported by the terminal device; a name of a band for uplink transmission supported by the terminal device; or an index of a band group for uplink transmission supported by the terminal device.

In an embodiment, the processing module 1310 includes a sending unit 1312.

The sending unit 1312 is configured to send first indication signaling used to indicate whether the at least two bands support uplink concurrent transmission, or send second indication signaling used to indicate at least one band pair that is allowed to be switched, or send third indication signaling used to indicate a priority of at least one band.

In an embodiment, the first indication signaling carries a bitmap, and one bit in the bitmap corresponds to one band pair or one band.

In some embodiments, the one bit in the bitmap corresponds to the one band pair.

In a case where a bit is a first value, it indicates that a band pair corresponding to the bit supports uplink concurrent transmission; and
in a case where a bit is a second value, it indicates that a band pair corresponding to the bit does not support uplink concurrent transmission.

In some embodiments, a quantity of bits in the bitmap is a first quantity N.

In a case where a quantity of band pairs indicated by a network device or a quantity n1 of band pairs reported by the terminal device is less than the first quantity N, n1 high-order bits in the bitmap are valid bits, and n1 is less than N; and in a case where a quantity of band pairs indicated by a network device or a quantity n2 of band pairs reported by the terminal device is less than the first quantity N, n2 low-order bits in the bitmap are valid bits, and n2 is less than N.

In some embodiments, the one bit in the bitmap corresponds to the one band pair.

In a case where a bit is a first value, it indicates that a first band corresponding to the bit supports uplink concurrent transmission with a second band, and the second band is a band corresponding to another bit having the first value in the bitmap; and in a case where the bit is a second value, it indicates that the first band does not support uplink concurrent transmission.

In some embodiments, the first indication signaling carries a first code point. The first code point corresponds to a band set and is used to indicate that at least two bands in the band set support uplink concurrent transmission.

In some embodiments, the first indication signaling carries a second code point. The second code point corresponds to a band and is used to indicate that the band does not support uplink concurrent transmission.

In some embodiments, in a case where the first indication signaling carries single-bit information, the single-bit information is used to indicate whether a target band supports uplink concurrent transmission.

The target band includes any one of: all bands; a band that is indicated as allowed for switching; or a band with a specified priority.

In a case where the single-bit information is a first value, it indicates that the target band supports uplink concurrent transmission; and in a case where the single-bit information is a second value, it indicates that the target band does not support uplink concurrent transmission.

In an embodiment, in a case where a quantity of bands in the at least one band group is not greater than a maximum value M, all bands in the at least one band group support uplink concurrent transmission, and in a case where the quantity of bands in the at least one band group is greater than the maximum value M, M bands in the at least one band group support uplink concurrent transmission.

The M bands are first M bands in predetermined order in the at least one band group; or the M bands are last M bands in predetermined order in the at least one band group. The predetermined order is any one of a descending order of frequencies, an ascending order of frequencies, an ascending order of indexes of bands, or a descending order of indexes of bands.

In an embodiment, first M bands in priority order support uplink concurrent transmission, and M is a maximum quantity of bands for uplink concurrent transmission supported by the terminal device.

According to the present disclosure, a method and device for determining band information, a device, a medium, and a program product are provided. The technical solution at least includes the following.

According to an aspect of the embodiments of the present disclosure, a method for determining band information is provided. The method includes: determining whether at least two bands support uplink concurrent transmission.

According to another aspect of the embodiments of the present disclosure, a method for determining band information is provided. The method includes: sending indication signaling, where the indication signaling is used for a terminal device to determine whether at least two bands support uplink concurrent transmission.

According to another aspect of the embodiments of the present disclosure, a device for determining band information is provided. The device includes: a processing module, configured to determine whether at least two bands support uplink concurrent transmission.

According to another aspect of the embodiments of the present disclosure, a device for determining band information is provided. The device includes: a processing module, configured to send indication signaling, where the indication signaling is used for a terminal device to determine whether at least two bands support uplink concurrent transmission.

According to another aspect of the embodiments of the present disclosure, a terminal device is provided. The terminal device includes: a processor; and a transceiver connected to the processor; where the processor is configured to load and execute executable instructions to implement the method for determining the band information according to any one of the foregoing aspects.

According to another aspect of the embodiments of the present disclosure, a network device is provided. The network device includes: a processor; and a transceiver connected to the processor; where the processor is configured to load and execute executable instructions to implement the method for determining the band information according to any one of the foregoing aspects.

According to another aspect of the embodiments of the present disclosure, a non-transitory computer-readable storage medium is provided. The non-transitory computer-readable storage medium stores at least one instruction, at least one program, a code set, or an instruction set, and the at least one instruction, the at least one program, the code set, or the instruction set is loaded and executed by a processor to implement the method for determining the band information according to any one of the foregoing aspects.

According to another aspect of the embodiments of the present disclosure, a computer program product (or a computer program) is provided. The computer program product (or the computer program) includes computer instructions, and the computer instructions are stored in a computer-readable storage medium. A processor of a computer device reads the computer instructions from the computer-readable storage medium, and the processor executes the computer instructions, so that the computer device performs the method for determining the band information according to any one of the foregoing aspects.

Here, the term processor may refer to one processor that performs the defined functions or a plurality of processors that collectively perform defined functions, such that the execution of the individual defined functions may be divided amongst such processors.

According to the present disclosure, whether the at least two bands support uplink concurrent transmission is determined by the terminal device, so that a quantity of bands corresponding to uplink concurrent transmission can be limited in an uplink Tx switching scenario to implement balance between complexity and switching flexibility. This reduces implementation complexity of the terminal device.

FIG. 14 is a schematic structural diagram of a terminal device 1400 according to an example of the present disclosure. The terminal device 1400 includes a processor 1401, a receiver 1402, a transmitter 1403, a memory 1404, and a bus 1405.

The processor 1401 includes one or more processing cores. The processor 1401 runs a software program and a module, to execute various functional applications and perform data processing.

The receiver 1402 and the transmitter 1403 may be implemented as a communication component, and the communication component may be a communication chip.

The memory 1404 is connected to the processor 1401 via the bus 1405.

The memory 1404 may be configured to store at least one instruction. The processor 1401 is configured to execute the at least one instruction, to implement steps in the foregoing method embodiments.

In addition, the memory 1404 may be implemented by any type of volatile or non-volatile storage device or their combinations. The volatile or non-volatile storage device includes, but is not limited to, a magnetic disk, an optical disc, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

In an example, a non-transitory computer-readable storage medium including instructions is further provided, for example, a memory including instructions. The instructions may be executed by the processor of the terminal device to implement the method for determining band information. For example, the non-transitory computer-readable storage medium may be a ROM, a random-access memory (RAM), a compact disc read-only memory (CD-ROM), a tape, a floppy disk, an optical data storage device, or the like.

In some embodiments, the terminal device notifies, by reporting a capability of the terminal device or sending uplink control information, a base station of a preparation time of switching an antenna by the terminal device. The terminal device expects that the base station does not perform any uplink scheduling for the terminal device during the preparation time.

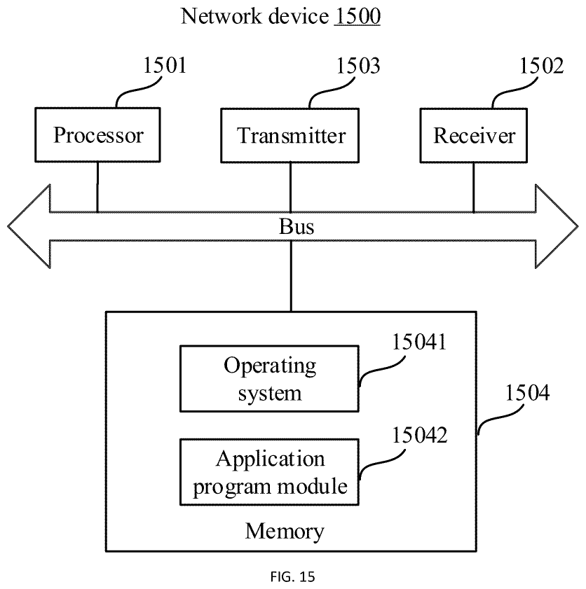

FIG. 15 is a schematic structural diagram of a network device 1500 according to an example of the present disclosure. The network device 1500 may be a base station.

The network device 1500 may include a processor 1501, a receiver 1502, a transmitter 1503, and a memory 1504. The receiver 1502, the transmitter 1503, and the memory 1504 are connected to the processor 1501 via a bus.

The processor 1501 includes one or more processing cores. The processor 1501 runs a software program and a module, to perform the method for determining band information provided in embodiments of the present disclosure. The memory 1504 may be configured to store the software program and the module. The memory 1504 may store an operating system 15041 and an application program module 15042 that is needed for at least one function. The receiver 1502 is configured to receive communication data sent by other devices, and the transmitter 1503 is configured to transmit the communication data to other devices.

In some embodiments, a base station indicates, via downlink signaling, to a terminal device a preparation time of switching an antenna by the terminal device. The base station does not perform any uplink scheduling for the terminal device during the preparation time. The downlink signaling includes, but is not limited to, RRC signaling, a MAC CE, and DCI.

According to an example of the present disclosure, a computer program product is provided. The computer program product includes computer instructions, and the computer instructions are stored in a computer-readable storage medium. A processor of a computer device reads the computer instructions from the computer-readable storage medium, and the processor executes the computer instructions, so that the computer device performs the method for determining band information in the forgoing method embodiments.

It is to be understood that “a plurality of” in the specification means two or more. Those skilled in the art can easily figure out another implementation solution of the present disclosure after considering the specification and practicing the present invention disclosed here. The present disclosure is intended to cover any variations, functions, or adaptive changes of the present disclosure. These variations, functions, or adaptive changes comply with general principles of the present disclosure, and include common knowledge or a commonly used technical means in the technical field that is not disclosed in the present disclosure. The specification and embodiments are considered as examples, and the true scope and spirit of the present disclosure are indicated by the appended claims.

It is to be understood that the present disclosure is not limited to the precise structures that have been described and illustrated in the accompanying drawings, and various modifications and changes may be made without departing from the scope of the present disclosure. The scope of the present disclosure is limited only by the appended claims.

1. A method for determining band information, performed by a terminal device, comprising:
determining whether at least two bands support uplink concurrent transmission.

2. The method according to claim 1, further comprising:
receiving first indication signaling, wherein the first indication signaling indicates whether the at least two bands support uplink concurrent transmission; and
determining whether the at least two bands support uplink concurrent transmission comprises:
determining, based on the first indication signaling, whether the at least two bands support uplink concurrent transmission.

3. The method according to claim 2, wherein the first indication signaling carries a bitmap, and one bit in the bitmap corresponds to one band pair or one band.

4. The method according to claim 3, wherein one bit in the bitmap corresponds to one band pair, and wherein:
in a case where a bit is a first value, it indicates that a band pair corresponding to the bit supports uplink concurrent transmission; and
in a case where a bit is a second value, it indicates that a band pair corresponding to the bit does not support uplink concurrent transmission.

5. The method according to claim 3, wherein a quantity of bits in the bitmap is a first quantity N; and wherein:
in a case where a quantity n1 of band pairs indicated by a network device or reported by the terminal device is less than the first quantity N, n1 high-order bits in the bitmap are valid bits, and n1 is less than N; and
in a case where a quantity n2 of the band pairs indicated by the network device or reported by the terminal device is less than the first quantity N, n2 low-order bits in the bitmap are valid bits, and n2 is less than N.

6. The method according to claim 3, wherein one bit in the bitmap corresponds to one band, and wherein:
in a case where a bit is a first value, the first value indicates that a first band corresponding to the bit supports uplink concurrent transmission with a second band, and the second band is a band corresponding to another bit with the first value in the bitmap; and
in a case where the bit is a second value, the second value indicates that the first band does not support uplink concurrent transmission.

7. The method according to claim 2, wherein
the first indication signaling carries a first code point, the first code point corresponds to a band set, and the first code point is configured to indicate that at least two bands in the band set support uplink concurrent transmission; or the first indication signaling carries a second code point, the second code point corresponds to a band, and the second code point is configured to indicate that the band does not support uplink concurrent transmission.

8. (canceled)

9. The method according to claim 2, wherein the first indication signaling carries single-bit information, and the single-bit information is configured to indicate whether a target band supports uplink concurrent transmission.

10. The method according to claim 9, wherein the target band comprises at least one of:
all bands;
a band that is indicated as allowed for switching; or
a band with a specified priority.

11. The method according to claim 9, wherein
in a case where the single-bit information is a first value, the first value indicates that the target band supports uplink concurrent transmission; and
in a case where the single-bit information is a second value, the second value indicates that the target band does not support uplink concurrent transmission.

12. The method according to claim 1, further comprising:
receiving second indication signaling, wherein the second indication signaling indicates at least one band pair that is allowed to be switched; and
determining whether the at least two bands support uplink concurrent transmission comprises:
determining, in a case where a quantity of bands in at least one band group is not greater than a maximum value M, based on the second indication signaling, that all bands in the at least one band group support uplink concurrent transmission; and determining, in a case where the quantity of bands in the at least one band group is greater than the maximum value M, that M bands in the at least one band group support uplink concurrent transmission.

13. The method according to claim 12, wherein
the M bands are first M bands in predetermined order in the at least one band group; or
the M bands are last M bands in the predetermined order in the at least one band group; wherein
the predetermined order is any one of a descending order of frequencies, an ascending order of frequencies, an ascending order of indexes of bands, or a descending order of indexes of bands.

14. The method according to claim 1, comprising:
receiving third indication signaling, wherein the third indication signaling indicates a priority of at least one band; and
determining whether the at least two bands support uplink concurrent transmission comprises:
determining, based on the third indication signaling, that first M bands in priority order support uplink concurrent transmission, wherein
M is a maximum quantity of bands for uplink concurrent transmission supported by the terminal device.

15. The method according to claim 12, further comprising:
reporting a maximum value M, wherein the maximum value M is a maximum quantity of bands for uplink concurrent transmission supported by the terminal device.

16. The method according to claim 1, further comprising:
reporting at least one of:
a total quantity of bands for uplink transmission supported by the terminal device;
an index of a band for uplink transmission supported by the terminal device;
a name of a band for uplink transmission supported by the terminal device; or
an index of a band group for uplink transmission supported by the terminal device.

17. A method for determining band information, performed by a network device, comprising:
sending indication signaling, wherein the indication signaling is configured for a terminal device to determine whether at least two bands support uplink concurrent transmission.

18-34. (canceled)

35. A terminal device, comprising:
one or more processors; and
a transceiver connected to the one or more processors, wherein
the one or more processors are collectively configured to method for determining band information:
determine whether at least two bands support uplink concurrent transmission.

36. A network device, comprising:
one or more processors; and
a transceiver connected to the one or more processors, wherein
the one or more processors are collectively configured to load and execute executable instructions to perform the method for determining band information according to claim 17.

37. (canceled)

38. A non-transitory computer-readable storage medium, storing at least one instruction, at least one program, a code set, or an instruction set, wherein the at least one instruction, the at least one program, the code set, or the instruction set is loaded and executed by one or more processors to implement the method for determining band information according to claim 1.

39. A non-transitory computer-readable storage medium, storing at least one instruction, at least one program, a code set, or an instruction set, wherein the at least one instruction, the at least one program, the code set, or the instruction set is loaded and executed by one or more processors to implement the method for determining band information according to claim 17.
